(19) United States
(12) Patent Application Publication
(10) Pub. No.: US 2010/0173049 A1
(43) Pub. Date: Jul. 8, 2010

(54) REDUCED SUGAR RAISIN AND METHOD

(76) Inventors: Alicia A. Perdon, Battle Creek, MI (US); Michael N. Bauman, Battle Creek, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 12/089,232

(22) PCT Filed: Feb. 14, 2008
(86) PCT No.: PCT/US08/53993

§ 371 Date: Apr. 4, 2008

Related U.S. Application Data
(60) Provisional application No. 60/889,750, filed on Feb. 14, 2007.

(51) Int. Cl. A23B 7/02; A23B 7/153; A23L 1/307

(52) U.S. Cl. 426/281; 426/640; 426/548

(57) ABSTRACT

A method of producing a raisin from a grape is disclosed herein. The method includes the step of diffusing a portion of natural sugar out of a grape. The grape has an outer skin enclosing pulp and liquid. The natural sugar is diffused to reduce a sweetness of the grape from an original level of sweetness. The method includes the step of infusing an alternative sweetener into the grape after the diffusing step. The amount of artificial sweetener infused by the grape substantially compensates for the loss of sweetness associated with the portion of natural sugar that was diffused out the grape during said diffusing step. The method includes the step of dehydrating the grape to produce a raisin having a sweetness defined by the combination of natural sugar and alternative sweetener.

### CROSS-REFERENCE TO RELATED APPLICATIONS

This application claims the benefit of U.S. Provisional Patent Application Ser. No. 60/889,750 for a REDUCED SUGAR RAISIN AND METHOD, filed on Feb. 14, 2007, which is hereby incorporated by reference in its entirety.

### BACKGROUND OF THE INVENTION

1. Field of the Invention

The present invention relates to a method for producing a fruit piece such as a raisin.

2. Description of the Prior Art

Raisins are made by dehydrating grapes by sun drying or air drying with either heated or ambient air. Grapes have a generally smooth outer skin that encloses a pulp. Liquid or juice is dispersed throughout the pulp of the grape. Natural sugar is dispersed throughout the liquid and pulp of the grape. This natural sugar establishes and defines a level of sweetness for the grape. Each of the drying techniques set forth above results in the removal of liquid from the grape. The pulp, skin, and the natural sugar of the grape remain, defining the raisin.

### SUMMARY OF THE INVENTION

In summary, the invention is a method of producing a raisin from a grape. The method includes the step of diffusing a portion of natural sugar out of a grape. The grape has an outer skin enclosing pulp and liquid. The natural sugar is diffused to reduce a sweetness of the grape from an original level of sweetness. The method includes the step of infusing an alternative sweetener into the grape after the diffusing step. The amount of artificial sweetener infused by the grape substantially compensates for the loss of sweetness associated with the portion of natural sugar that was diffused out the grape during said diffusing step. The method includes the step of dehydrating the grape to produce a raisin having a sweetness defined by the combination of natural sugar and alternative sweetener.

### BRIEF DESCRIPTION OF THE DRAWING

Advantages of the present invention will be readily appreciated, as the same becomes better understood by reference to the following detailed description when considered in connection with the accompanying drawing wherein:

FIG. 1 is a simplified flow diagram illustrating the steps of the exemplary embodiment of the invention.

### DETAILED DESCRIPTION OF THE EXEMPLARY EMBODIMENT

Grapes are edible and have an outer skin enclosing a pulp, which is a soft, fleshy, fibrous and porous material. Liquid or juice is dispersed throughout the pulp of the grape. An original amount of natural sugar is also dispersed throughout the grape. This original amount of natural sugar in each grape establishes an original level of sweetness.

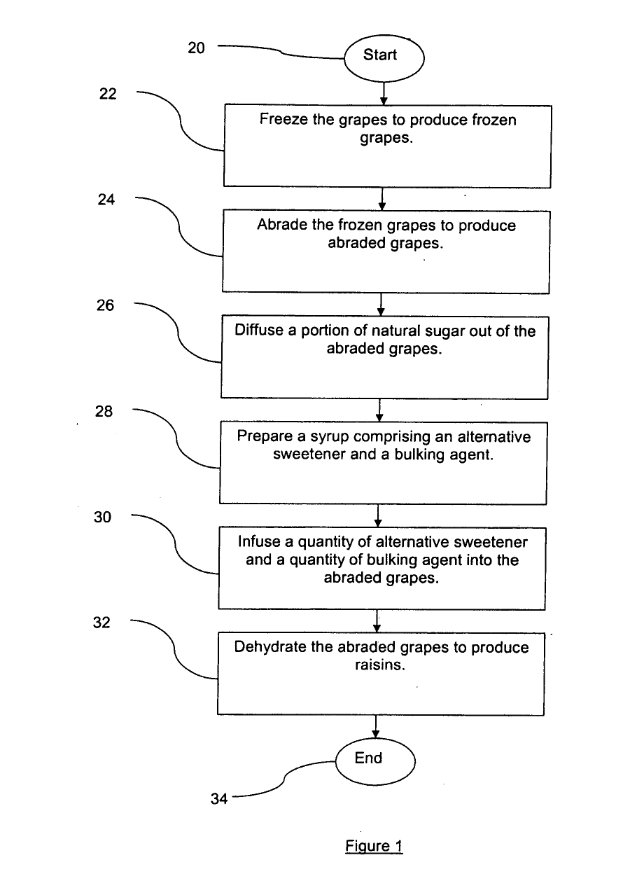

The method according to the exemplary embodiment of the invention is shown schematically in FIG. 1. The method starts at step 20. At step 22, the grapes are frozen. The freezing step may be accomplished by maintaining the grapes in an environment in which the temperature is below 32° F. for a time sufficient to solidify the pulp and liquid of the grapes. Optionally, various time and temperature combinations known in the art can be employed to sufficiently freeze the pulp and liquid of the grapes. Alternative embodiments of the invention may be practiced wherein only an outer portion of the grapes are frozen or partially frozen, an interior core portion of the grape remaining unfrozen. Freezing can be desirable to make the grapes substantially rigid for subsequent processing, as will be described below. However, freezing is not required for practicing the invention. The inventions can be practiced with fresh fruit.

At step 24, the frozen grapes are abraded to remove a portion of the skin from each grape. The skin of a grape can be a barrier to sugar diffusion or infusion (described below). The removal of the portion of the skin can be desirable to facilitate the diffusion of natural sugar out of the grapes as well as to facilitate the infusion of an alternative sweetener into the grapes, which will be described in greater detail below. Cracking, splitting, partially peeling, scarifying the grape can be a necessary step to creating an economically scaleable production process. As a result, the pulp of each grape is partially exposed in the exemplary embodiment of the invention. While it is possible to remove virtually all of the skin from frozen grapes, this may generate unnecessary waste. This defusion/infusion process will work with 5 to 50% of the skin removed if the abrading approach is used. The abrading may be accomplished by tumbling the frozen grapes against an abrasive texture of an inner wall of a rotating drum. This step can also be accomplished by contacting the frozen grapes against any abrasive surface known in the art.

At step 26, a portion of the natural sugar is diffused out of the grapes. The diffusing step results in the grapes having a reduced level of sweetness from an original level of sweetness. In the exemplary embodiment of the invention, this diffusion is accomplished by soaking grapes having exposed pulp in water at a temperature of 110° F. for 90 minutes.

Preferably, the water is preheated before the frozen grapes are added. Adding the frozen grapes temporarily decreases the water temperature, however the diffusion water can be circulated through a heat exchanger to maintain the desired temperature. The temperature of the water can be increased during the diffusion process if desired. For example; it may be desirable to heat the grapes and water to a temperature of 145° F. within 30 minutes after the start of the diffusing step to effectively pasteurize the mixture of grapes and water.

The grapes can be placed in a quantity of water can be such that the ratio of grapes to water is 1 to 3. However, the quantity of water, soaking duration, and water temperature can be varied to achieve any desired level of diffusion. The diffusion of a portion of the natural sugar in the grapes can be successful at ratios of grapes to water of roughly 1 to 2 at the low end to 1 to 5 or more. The optimum ratio of grapes to diffusion water will be determined largely by the amount of natural sugar one wants to extract from the grape. The higher the percentage of sugar to be extracted, the higher the ratio of water to grapes. It is also possible to use more than one diffusion cycle if desired.

The solution of extracted natural sugar and water that is obtained as a result of the diffusing step can be utilized for other purposes if desired. Depending upon the ultimate usage of the spent diffusion syrup, it may be necessary to achieve pasteurization temperatures of approximately 145 degrees F. early in the diffusion cycle to prevent and control microbiological growth.

The steps of exposing the pulp and then diffusing set forth above substantially reduces the likelihood that the pulp of each grape is not irreparably damaged. One advantage of the exemplary embodiment of the invention is that the finished raisin of the exemplary embodiment of the invention will enjoy an appearance similar to raisin produced by prior art methods. In other words, the pulp of each grape is not damaged such as occurs in pressing or other juicing technologies. In addition, abrading the skin substantially minimizes the damage to the skin that occurs to expose the pulp.

In an alternative embodiment of the invention, individually quick frozen (IQF) whole Thompson grapes are sized and optionally color sorted. The IQF grapes are kept at a temperature of from −15 to 0° C. during the sorting and sizing process so that they remain frozen. The IQF grapes are sorted by retaining all those grapes that pass through a mesh screen with 16 millimeter openings but are retained on a screen with openings of 9 millimeters. The mesh sizes may differ in other embodiments of the invention as desired. The IQF grapes are then kept frozen and scarified, the temperature of from −15 to 0° C. maintained during the scarification. Like the abrading process set forth above, the scarification process results in the pulp of each grape being exposed. Unlike abrading, scarification cuts slits through the skin into the grape rather than partially peeling the grape.

The naturally occurring sugars from the scarified IQF grapes can then be diffused. The IQF grapes can be placed into water at a weight ratio of 1:2 to 1:4 of grapes to water. The solution is preferably preheated to a temperature of from 29 to 44° C.±5° C. Adding the frozen grapes temporarily decreases the water temperature, however the diffusion solution is recirculated through a heat exchanger and kept at a temperature of from 29 to 44° C.±5° C. during the diffusion.

In yet another alternative embodiment of the invention, freshly harvested grapes are cleaned and, while at ambient temperature, can be either partially peeled as previously disclosed or scarified. While there is significant energy savings in working with freshly harvested grapes, the season is relatively short which makes it difficult to process significant quanitites of the grapes into a room temperature stable form of reduced sugar raisins. Diffusion in a water solution could proceed according to either process described above.

The exemplary process continues from step 26 to step 28 and a syrup comprising the alternative sweetener and a bulking agent is prepared. A bulking agent can be desirable because the grapes will experience a loss of volume during the diffusing step in addition to the loss of natural sugar. In the exemplary embodiment of the invention, each of the grapes can experience a volume reduction of approximately 60%.

The syrup can comprise, by weight, 40% maltodextrin, 10% glycerin, 0.1% sucralose, and 49.9% water. The maltodextrin serves as the bulking agent. 20 DE maltodextrin can be used for practicing the invention. The glycerin serves as a texture enhancer. The sucralose serves as the alternative sweetener. Other known bulking agents, alternative sweeteners, both natural, e.g. Luo Han Guo extracts, Stevia extracts such as Rebiana, and artificial sweeteners, e.g. aspartame, can be utilized. Litesse Ultra polydextrose can be used as a soluble fiber for practicing the invention. In the case of sugar alcohols, e.g. sorbitol, xylitol, the infusion solution can contain up to 50% sugar alcohol. Once prepared, the syrup can be heated. In the exemplary embodiment, the syrup is heated to 110° F.

Another example of a syrup for practicing the invention can include 30% polydextrose such as Litesse Ultra polydextrose, 10% glycerin, 0.1% sucralose, and 59.9% water.

The alternative sweetener can be synthetic. The alternative sweetener can be relatively high-intensity, natural or artificial, such as Brazzein, saccharin, cyclamate, asulfamane K, aspartame, alitame, Sucralose, and neotame. The alternative sweetener can be natural, such as thaumatin, glycyrrhizin, and steviosides. The alternative sweetener can be a sugar alcohol such as sorbitol, mannitol, xylitol, lactitol, maltitol, isomalt, hydrogenated starch hydrolyzates, isomaltulose, treahalose, and erythritol.

The exemplary process continues to step 30 and a quantity of the alternative sweetener and bulking agent is infused into each of the grapes. At this stage of the process, the pulp of the grape is exposed and portion of the natural sugar of each grape has been removed by diffusion. Infusion of the alternative sweetener can be driven by osmotic pressure.

In the exemplary embodiment, the infusing step is performed by soaking the previously-diffused grapes in the heated syrup for 270 minutes. The quantity of alternative sweetener and bulking agent infused into the previously-diffused grapes can be varied by varying the composition of the syrup, the concentration of the syrup, the ratio of grapes to syrup, the infusion temperature, the infusion time, and the number of infusion cycles. Soaking the previously-diffused grapes in the syrup causes a portion of the syrup, which contains the alternative sweetener and the bulking agent, to be transferred into each of the previously-diffused grapes. Examples of bulking agents include hyrdolized gums (such as Sun Fiber—R), soluble corn fiber (such as Promitor), maltodextrins, inulin, FOS, and resistant dextrims (such as Nutriose or Fibersol—2). Soluble fibers, complex carbohydrates, and other larger molecular weight macro-nutrients may be included in the syrup and thereby be infused into the previously-diffused grapes during Step 30. Other possible soluble fibers for practicing the invention include beta-glucan, galactomannan, conjack, arabinoxylanes, and hyrdolized form or non-hyrdolized form.

In the exemplary embodiment of the invention, an amount of alternative sweetener is infused into each previously-diffused grape such that the taste of a raisin produced from the previously-diffused and subsequently-infused grape is substantially the same as a raisin produced according to prior art methods of raisin production. The sweetness of a raisin produced from a previously-diffused and subsequently-infused grape processed according to the exemplary embodiment of the invention will be substantially the same as the sweetness of a raisin produced from dehydrating grapes off the vine. The sweetness of the alternative sweetener compensates substantially equally for the sweetness lost due to the loss of the portion of natural sugar diffused out of the grapes in the diffusing step.

In addition, the bulking agent infused into the previously-diffused grapes increase the volume of the grapes subjected to diffusion. The volume of the previously-diffused and subsequently-infused grape substantially returns to an original volume. In other words, in the exemplary embodiment of the invention, the grapes have substantially the same volume after step 30 as the grapes had prior to step 26. More significantly, reduced sugar grapes that are dried without a bulking agent in the infusion syrup are very shriveled and wrinkled. Adding bulking agents like maltodextrins, inulin, FOS, etc to the infusion syrup can result in reduced sugar raisins which look like and eat like regular raisins.

At the conclusion of step 30, each grape will have essentially the same form, volume, and level of sweetness it had prior to processing. However, each grape can have at least 50% by weight less natural sugar. Further, the level of sweetness of each grape will be established by a combination of natural sugar and alternative sweetener. The amount of alternative sweetener in each grape is about 0-1% by weight in the exemplary embodiment of the invention. Prior to processing, the level of sweetness was established solely by the amount of natural sugar in each grape.

The process continues to step 32 and the previously-diffused and subsequently-infused grapes are dehydrated to remove water and form raisins. In the exemplary embodiment of the invention, the previously-diffused and subsequently-infused grapes become sweetener-infused raisins after being dehydrated. As an example, the dehydrating can be accomplished by hot air drying at 170° F.-185° F. for 3-5 hours, after which dehydrating each raisin has a liquid content of 10-14% by weight. Alternatively, air drying or sun drying can be utilized to achieve the same result. Oil or glycerin can be applied to the raisins as desired to address stickiness. The exemplary process ends at step 34.

The present invention provides both a method of producing raisins and raisins themselves. A raisin is not shown in the drawings of the application since the raisin of the exemplary embodiment of the invention will not appear different from a raisin produced according to prior art methods. In the exemplary embodiment, the raisin has a wrinkled skin, a quantity of raisin pulp at least partially contained with the wrinkled skin, and a certain minimal level of moisture intermixed with the raisin pulp. The wrinkled skin of the raisin may not entirely enclose the raisin pulp based on the process applied for exposing the pulp prior to the diffusing step. The sweetener-infused raisins of the exemplary embodiment look and taste the same as conventional raisins. Possible alternative embodiments of the invention can be practiced where the finished raisins are sweeter than conventional raisins. The sweetener-infused raisins can also provide the same mouth feel as conventional raisins. A conventional raisin is a raisin having a level of sweetness fully defined by natural sugar.

The characteristics defining the physical appearance of a raisin are not quantifiable in numerical terms. Similarly, the taste and mouth feel of any edible product are not measurable with the same level of precision and repeatability as properties such as length, weight and density. However, those of ordinary skill in the art and consumers will appreciate that a raisin manufactured according to the exemplary embodiment appears, tastes and conveys a mouth feel that is substantially similar to conventionally-manufactured raisins.

The exemplary process set forth above can also be applied for producing prunes from plums.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

What is claimed is:

1. A method of producing a raisin from a grape comprising the steps of:
diffusing a portion of natural sugar out of a grape having an outer skin and pulp and liquid to reduce a sweetness of the grape from an original level of sweetness;
infusing an alternative sweetener into the grape after said diffusing step in an amount to substantially compensate for loss of sweetness associated with the portion of natural sugar diffused out the grape during said diffusing step; and
dehydrating the grape to produce a raisin having a sweetness defined by the combination of natural sugar and alternative sweetener.

2. The method of claim 1 further comprising the step of:
at least partially freezing the grape prior to said diffusing step.

3. The method of claim 1 further comprising the step of:
removing at least a portion of the outer skin of the grape prior to said diffusing step.

4. The method of claim 3 wherein said removing step is further defined as:
abrading the grape prior to said diffusing step.

5. The method of claim 1 further comprising the step of:
infusing a bulking agent into the grape after said diffusing step.

6. The method of claim 5 wherein said infusing step is further defined as:
infusing a bulking agent into the grape after said diffusing step in an amount to substantially just compensate for loss of a volume experience by the grape during said diffusing step.

7. The method of claim 5 wherein said infusing step is further defined as:
infusing a bulking agent in the form of soluble fiber into the grape after said diffusing step.

8. The method of claim 5 wherein said infusing step is further defined as:
infusing a complex carbohydrate into the grape after said diffusing step.

9. The method of claim 1 further comprising the step of:
exposing the pulp of the grape prior to said diffusing step.

10. A raisin manufactured according to the method of claim 1.

11. An article of manufacture in the form of raisin, having a sweetness defined at least partially by an alternative sweetener.

12. The raisin of claim 11 wherein said sweetness is defined a combination of alternative sweetener as well as naturally-occurring sugar.

13. The raisin of claim 11 further defined as being substantially similar in physical form to a raisin having a level of sweetness fully defined by natural sugar.

14. The raisin of claim 11 further defined as tasting substantially similar to a raisin having a level of sweetness fully defined by natural sugar.

15. The raisin of claim 11 further defined as imparting a mouth feel substantially similar to a raisin having a level of sweetness fully defined by natural sugar.

16. A method of producing a raisin from a grape comprising the steps of:
diffusing a portion of natural sugar out of a grape having an outer skin and pulp and liquid to reduce a sweetness of the grape from an original level of sweetness;
infusing a bulking agent into the grape after said diffusing step to substantially compensate for the loss of volume occurring during said diffusing step; and
dehydrating the grape to produce a raisin having a sweetness defined by the combination of natural sugar and alternative sweetener.

17. The method of claim 16 wherein said infusing step is further defined as:
infusing a bulking agent into the grape after said diffusing step in an amount to substantially just compensate for loss of a volume experience by the grape during said diffusing step.
